(19) United States
(12) Patent Application Publication
(10) Pub. No.: US 2006/0151300 A1
(43) Pub. Date: Jul. 13, 2006

(54) Pallet for conveyor chain

(76) Inventor: Rene Lucien Blasi, Montlignon (FR)

Correspondence Address: HARNESS, DICKEY & PIERCE, P.L.C., P.O. BOX 828, BLOOMFIELD HILLS, MI, 48303, US

(21) Appl. No.: 11/150,840

(22) Filed: Jun. 10, 2005

Related U.S. Application Data
(63) Continuation of application No. PCT/FR03/03679, filed on Nov. 12, 2003.

(30) Foreign Application Priority Data
Nov. 12, 2002 (FR) 0215650

(51) Int. Cl. B65G 17/16

(52) U.S. Cl. 198/793

(57) ABSTRACT

The invention concerns a pallet for a conveyor chain comprising a chain and guide walls defining a path including straight portions and portions with maximum curvature, each pallet comprising a leading edge and a trailing edge and two lateral edges designed to co-operate with the guide walls. The leading and trailing edges of each pallet are configured such that the leading edge of a pallet, the trailing edge of an adjacent pallet, and the lateral edges of said pallets define with the guide walls, in the plane of the pallets, surfaces of dimensions greater than predetermined dimensions in one straight path portion as well as in a path portion with maximum curvature, so as to prevent an operator's finger form getting caught.

### CROSS-REFERENCE TO RELATED APPLICATIONS

This application is a continuation of PCT/FR2003/003679, filed Dec. 11, 2003 and claims priority to French Patent No. FR 0215650, filed Dec. 11, 2002. The disclosures of the above applications are incorporated by reference herein.

### BACKGROUND AND SUMMARY OF THE INVENTION

The present invention concerns a pallet for a conveyor chain, more particularly such a pallet arranged to be fixed to a drive chain able to drive a succession of pallets substantially in one plane in a direction of driving along a path able to comprise straight portions and portions of maximum curvature, the said pallet comprising a front edge and a rear edge with respect to its driving direction, and two lateral edges each able to describe an envelope during the movement of the pallet along the path. Conveyors using pallets of this type are already known. These conveyors are for example used in engineering workshops for moving parts from one station to another. The pallets serve as a support for the parts being transported.

The pallets are fixed by any means, including by forming an integral part thereof, to chain links, generally links with sockets, rollers or universal drives. In the case of chains with sockets or rollers, the axis of the sockets or rollers are disposed substantially vertically in the conveyor and the pallets are fixed to the connection spindles between links, so as to be situated horizontal.

Chains with sockets have good tensile strength, which makes it possible to achieve sinuous paths of great length. They also allow driving by the side, which is particularly economical. Another advantage of these chains with sockets lies in the fact that the path of the pallets may be entirely in one horizontal plane and therefore used over its entire length, without a return length below the useful length. The guidance of the chain is achieved by links which slide in a profiled section or an assembled profiled section.

The curves on the path are made possible by the shape of the pallets, which enables them to be oriented with respect to one another in their plane. The pallets move between the guide walls, which project above the top surface in order to guide the objects being transported.

In the design of the pallets, pains are taken to ensure that the greatest possible usable surface is available for supporting the objects to be transported, that is to say substantially the entire surface lying between the two guide walls. In this way the drive forces are increased by friction of the transported objects on the pallets. Such is the case in particular for the conveyor described in the document FR 2 297 788, which makes provision for filling in substantially the entire space present between two successive pallets by an intermediate element in the shape of a butterfly, in order to increase the carrying surface.

However, this conveyor has a certain number of drawbacks. When passing from a straight portion of the conveyor to a curved portion, the space between two intermediate elements narrows inside the curve, which may give rise to the jamming of an object, in particular the jamming of a finger. In particular, this problem of jamming is also posed during the passage from a curved portion on the conveyor to a straight portion. This is because the space between an intermediate element and an adjacent pallet, broadened outside the curve, narrows in the straight portion. Moreover, this conveyor requires the use of two different types of pallet and their precise relative positioning, which is expensive in terms of manufacture and assembly.

FIG. 1 shows another pallet chain 1 of the prior art. This figure illustrates the fact that the maximisation of the usable surface is generally obtained with pallets 2 whose front edge 3 and rear edge 4 are substantially circular with the same radius, one of these edges being convex and the other concave. Various shapes of pallet have already been produced on this principle. These edges 3 and 4 fit one in the other so that, both in the straight portion such as 5 and in the curves such as 6 approximately all the surface lying between the guide walls 7 is covered by the pallets. It can be seen however that, in the curved areas 6, the pallets separate and leave gaps 9 between them, in particular their lateral edges 7, and the guide walls 8. In these gaps, an object may be introduced inadvertently, or worse, the finger of an operator. When the pallet once again arrives in a straight portion of its path the gap closes up again and may amputate the trapped finger.

The document DE 299 22 101 U also describes a conveyor in which the carrying surface has been increased, via the use of pallets in the shape of a crescent, the concave face of a pallet cooperating with the convex face of an adjacent pallet. There also, in a curved portion of the conveyor, the movement of the pallets with respect to one another leads to an increase in the space formed between the pallets and the envelope of the external edge of the pallets, with respect to a curved portion of the conveyor. Consequently, on returning to a straight line, this space is narrowed, and may therefore cause the jamming of an object.

One objective of the invention is to provide a pallet conveyor that eliminates the risk of jamming of an object and, more particularly, that does not present any danger for an operator. To this end, and according to the first aspect of the invention, the object of the latter is a pallet for a conveyor chain, arranged so as to be fixed to a drive chain able to drive a succession of pallets substantially in one plane in a driving direction along a path able to comprise straight portions and portions of maximum curvature, the said pallet comprising a front edge and a rear edge with respect to its driving direction, and two lateral edges each able to describe an envelope during the movement of the pallet along the path, characterised by the fact that the said front, rear and lateral edges are conformed so that the front edge of a pallet, the rear edge of a substantially identical pallet adjacent to it on the drive chain and the lateral edges of these pallets delimit with the said envelopes surfaces with dimensions greater than predetermined dimensions both in a straight path portion and in a path portion of maximum curvature, so as to prevent the gripping of an object such as a finger of an operator.

Thus the invention prevents the risks of jamming, in particular by providing for the surfaces defined above not to be narrowed during passage from a curved portion to a straight portion or vice versa. In a particular embodiment, the pallet is substantially in the shape of a disc. However, other shapes could be envisaged, for example in an ellipse or a diamond. It will nevertheless be observed that, in all cases, the usual principle of the prior art, according to which the surface occupied by the pallets between the guide walls must be at a maximum, in particular in the straight portions of the conveyor, is abandoned.

According to another aspect of the invention, the object of the latter is a pallet chain, comprising a succession of links, at least some of the links carrying a pallet, in order to drive the pallet substantially in one plane in a driving direction along a path able to comprise straight portions and portions of maximum curvature, each pallet comprising a front edge and a rear edge with respect to its driving direction, and two lateral edges each able to describe an envelope during the movement of the pallet along the path, characterised by the fact that the said front and rear edges of each pallet and their lateral edges are conformed so that the front edge of a pallet, the rear edge of an adjacent pallet and the lateral edges delimit, with the said envelopes, surfaces with dimensions greater than predetermined dimensions both in a straight path portion and in a path portion of maximum curvature, so as to prevent the gripping of an object such as a finger of an operator. In a particular embodiment, the links can be socket links.

In one embodiment, at least one pallet is able to move in rotation about an axis, orthogonal to the plane of the pallets, with respect to the link of the chain carrying the said pallet. In another embodiment, at least one pallet is immobilised with respect to the link of the chain carrying the said pallet. To this end, each pallet can be carried by two adjacent socket spindles or, in a variant, carried by a single socket spindle, means of locking the rotation of the pallet about the said spindle then being provided. More particularly, each pallet can be carried by two adjacent socket spindles.

According to yet another aspect of the invention, the object of the latter is a chain conveyor comprising a pallet chain and a support provided with guide walls, the said pallet chain comprising a succession of links, at least some of the links carrying a pallet, for driving the pallet substantially in one plane in a driving direction along a path defined by the said guide walls and able to comprise straight portions and portions of maximum curvature, each pallet comprising a front edge and a rear edge with respect to its driving direction, and two lateral edges adjacent to the said guide walls, characterised by the fact that the said front, rear and lateral edges of each pallet are conformed so that the front edge of a pallet, the rear edge of an adjacent pallet and the lateral edges of these pallets delimit with the said guide walls, in the plane of the pallets, surfaces with dimensions greater than predetermined dimensions both in a straight path portion and in a path portion of maximum curvature, so as to prevent the gripping of an object such as the finger of an operator.

### BRIEF DESCRIPTION OF THE DRAWINGS

A particular embodiment of the invention will now be described, by way of non-limiting example, with reference to the accompanying schematic drawings, in which:

FIG. 1 is a plan view of a conveyor of the prior art and has already been described;

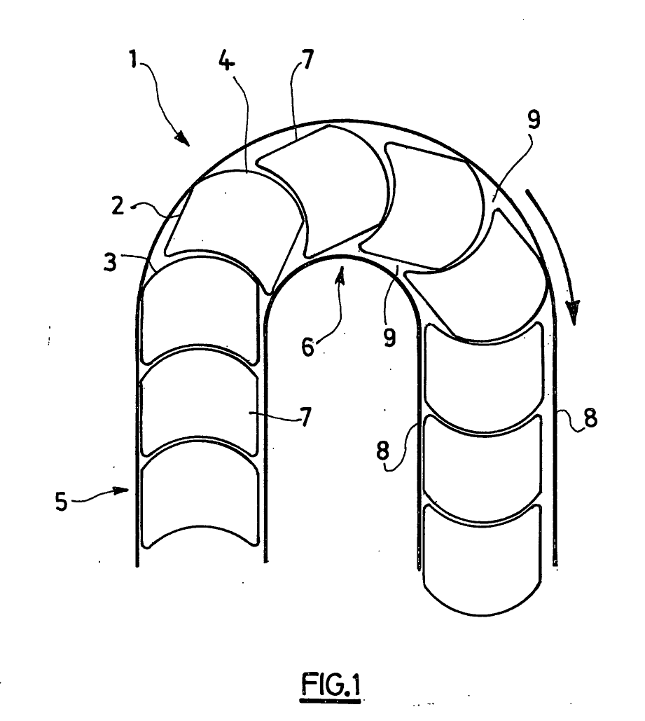

FIG. 2 is a view similar to FIG. 1 of a conveyor according to the invention;

FIG. 3 is a perspective view of a portion of this conveyor;

FIG. 4 is a view in transverse section thereof; and

FIG. 5 is another perspective view thereof.

### DETAILED DESCRIPTION

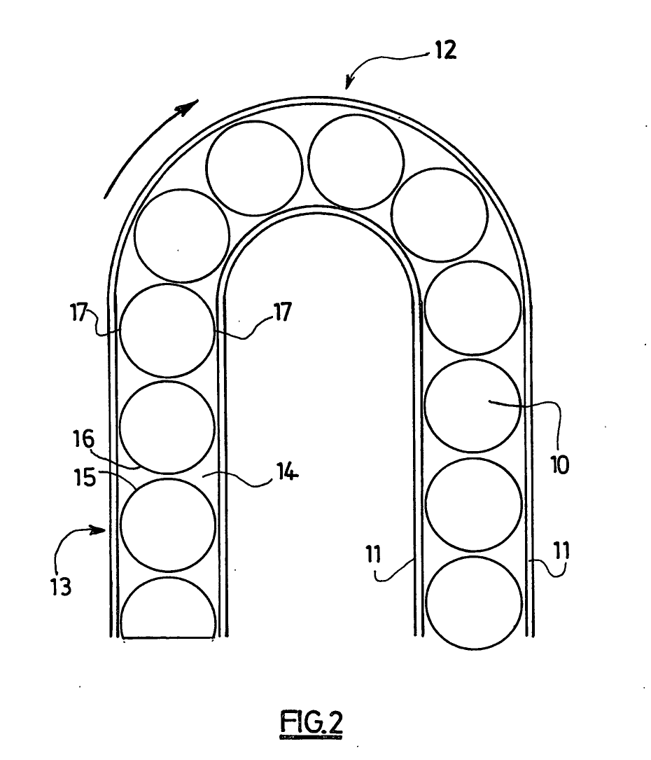

In FIG. 2 the pallets 10 and the guide walls 11 of the conveyor according to the invention can be seen. The conveyor comprises a succession of pallets 10 with substantially identical shapes. The pallets 10 have a shape, here circular, such that, both in the curves of maximum radius 12 and in the straight parts 13, the space 14 delimited by the rear edge 15 of a pallet, the front edge 16 of the pallet that follows it, the lateral edges 17 of these pallets and one of the guide walls 11 has sufficient surface for a finger of a user not being able to gripped therein.

The diameter of the pallets 10 is slightly less than the distance between the guide walls 11. The distance between the centres of two adjacent pallets 10 is slightly greater than the diameter of the pallets so that the front edge 15 of a pallet is as close as possible to the rear edge 16 of the pallet that precedes it and the drive surface of the conveyor is at a maximum. The pallets 10 are close to one another, but are separate and do not overlap, which in particular prevents risks of wear. In addition, no intermediate element that might cause problems of jamming is provided between two successive pallets 10.

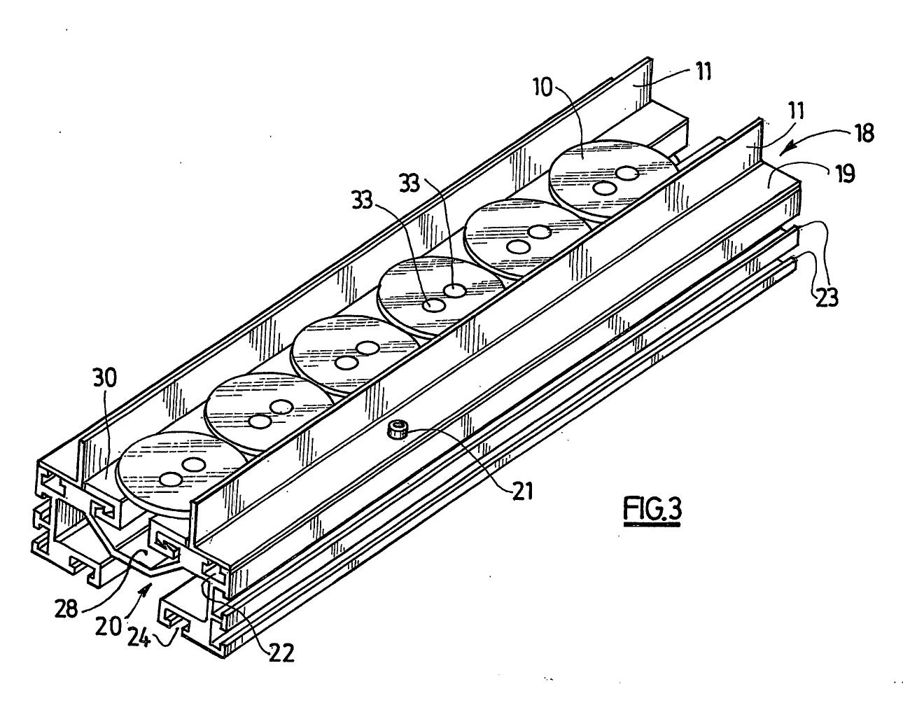

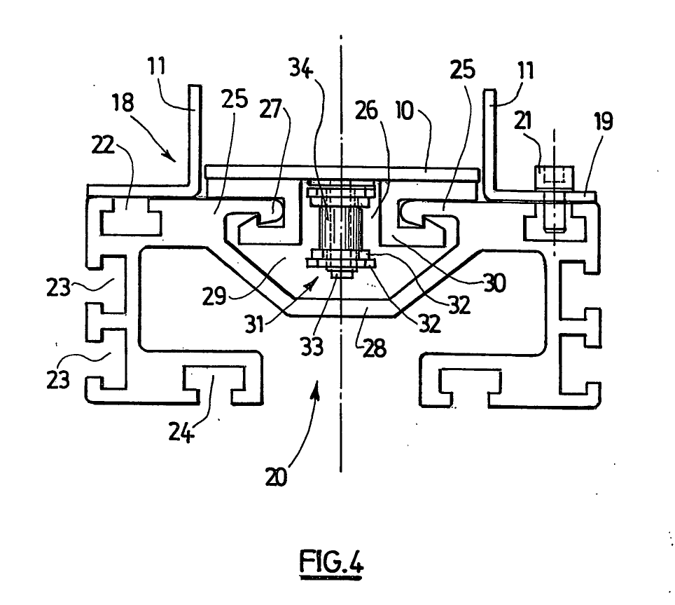

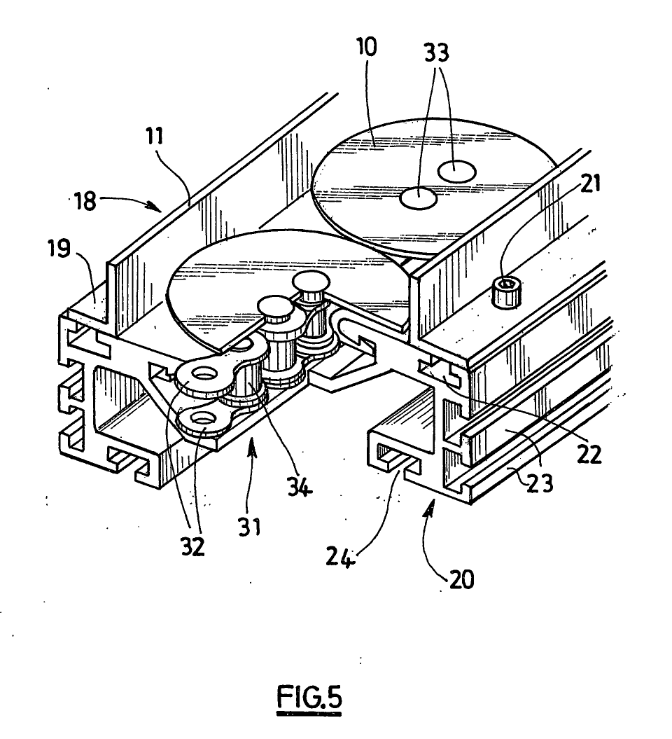

If reference is now made to FIGS. 3 to 5, it can be seen that each guide wall 11 is formed by one of the flanges of an angle girder 18. The other flange 19 of each angle girder 18 is fixed to a supporting profiled section 20 by means of bolts 21 cooperating with nuts (not shown) engaged and held in grooves 22 in the supporting profiled section 20. The supporting profiled section 20 also comprises two pairs of lateral grooves 23 for the fixing of accessories such as sensors or activators and two bottom mounting grooves 24 for fixing the profiled section to any suitable installation support.

The supporting profiled section 20 also forms two support ribs 25, substantially horizontal in the installed operating position, which extend from the outside of the profiled section towards its vertical plane of symmetry. The internal edges of the support ribs 25 delimit a longitudinal slot 26 and form a snapping-on profile 27. Finally, the supporting profile section 20 forms a connecting profiled section 28 transversely connecting the two support ribs 25 below the longitudinal slot 26. The support ribs 25 and the connecting profile 28 thus form a longitudinal chamber 29 open towards the top along the slot 26.

A sliding profiled section 30, generally in the form of a U and produced from synthetic material having good properties of slip and resistance to wear, is snapped onto each profile 27. Each sliding profiled section 30 covers the top surface of one of the support ribs 25 as well as the corresponding edge of the longitudinal slot 26. The conveyor chain 31 is a socket chain of a known type, the links 32 of which are connected by rivets 33 on which the sockets 34 are engaged.

Each pallet 10 is mounted on the chain by means of two successive rivets 33. In the present case, having regard to the relative values of the radius of the pallets 10 and the distance between the axes of the rivets 33, four successive rivets separate each group of two rivets carrying a pallet 10. Each pallet 10 is thus immobilised with respect to the chain and can in particular not pivot about its axis. This configuration is advantageous, in particular because it limits the wear on the palettes by the objects being transported.

Other embodiments making it possible to fix the pallets 10 to the chain without rotation are possible. For example, the pallet 10 can be carried by a single socket spindle, means of locking the rotation of the pallet 10 about its axis being provided. It is also possible to provide a single socket spindle carrying the pallet 10 without any means of immobilising the palette with respect to the spindle, and therefore with respect to the chain.

The chain 31 is disposed on the supporting profile 20 so that the face of the pallets 10 situated on the same side of the chain rests on the sliding profiled sections 30, the chain extending in the chamber 28 through the slot 26 which provides its guidance. Lateral driving means of any known type (not shown) drive the chain 31. The chain is guided by the pallets 10, which are themselves guided by the guide walls 11 of the angle girders 18. The invention thus provides a chain conveyor having good mechanical qualities and also not presenting any danger to its operators.

1. A pallet for a conveyor chain, arranged so as to be fixed to a drive chain able to drive a succession of pallets substantially in one plane in a driving direction along a path able to comprise straight portions and portions of maximum curvature, the pallet comprising a front edge and a rear edge with respect to its driving direction, and two lateral edges each able to describe an envelope during the movement of the pallet along the path, wherein the front, rear and lateral edges are conformed so that the front edge of a pallet, the rear edge of a substantially identical pallet adjacent to it on the drive chain and the lateral edges of these pallets delimit with the said envelopes surfaces with dimensions greater than predetermined dimensions both in a straight path portion and in a path portion of maximum curvature, so as to prevent the gripping of an object such as a finger of an operator.

2. A pallet according to claim 1, substantially in the shape of a disc.

3. A pallet chain, comprising a succession of links, at least some of the links carrying a pallet, in order to drive the pallet substantially in one plane in a driving direction along a path able to comprise straight portions and portions of maximum curvature, each pallet comprising a front edge and a rear edge with respect to its driving direction, and two lateral edges each able to describe an envelope during the movement of the pallet along the path, wherein the front, rear and lateral edges of each pallet are conformed so that the front edge of a pallet, the rear edge of an adjacent pallet and the lateral edges of these pallets delimit, with the envelopes, surfaces with dimensions greater than predetermined dimensions both in a straight path portion and in a path portion of maximum curvature, so as to prevent the gripping of an object such as a finger of an operator.

4. A chain according to claim 3, in which the pallets are substantially in the shape of a disc.

5. A chain according to claim 3, in which the links are socket links.

6. A chain according to claim 3, in which at least one pallet is able to move in rotation about an axis orthogonal to the plane of the pallets, with respect to the link of the chain carrying the said pallet.

7. A chain according to claim 3, in which at least one pallet is immobilised with respect to the link of the chain carrying the said pallet.

8. A chain according to claim 5, in which each pallet is carried by two adjacent socket spindles.

9. A chain according to claim 5, further comprising each of the pallets being carried by a single socket spindle, and means of locking the rotation of the pallet about the spindle.

10. A chain conveyor comprising a pallet chain and a support provided with guide walls, the pallet chain comprising a succession of links, at least some of the links carrying a pallet, for driving the pallet substantially in one plane in a driving direction along a path defined by the guide walls and able to comprise straight portions and portions of maximum curvature, each pallet comprising a front edge and a rear edge with respect to its driving direction, and two lateral edges adjacent to the guide walls, wherein the front, rear and lateral edges of each pallet are conformed so that the front edge of a pallet, the rear edge of an adjacent pallet and the lateral edges of these pallets delimit with the guide walls, in the plane of the pallets, surfaces with dimensions greater than predetermined dimensions both in a straight path portion and in a path portion of maximum curvature, so as to prevent the gripping of an object such as the finger of an operator.

11. A conveyor according to claim 10, in which the pallets are substantially in the shape of a disc.

12. A conveyor according to claim 10, in which the chain links are socket links.

13. A conveyor according to claim 12, further comprising each of the pallets being carried by two adjacent socket spindles.
